(19) United States
(12) Patent Application Publication
(10) Pub. No.: US 2003/0234811 A1
(43) Pub. Date: Dec. 25, 2003

(54) Home network system for driving a remote user interface and method thereof

(75) Inventor: Du-Il Kim, Suwon-si (KR)

Correspondence Address: SUGHRUE MION, PLLC, 2100 PENNSYLVANIA AVENUE, N.W., WASHINGTON, DC, 20037, US

(73) Assignee: SAMSUNG ELECTRONICS CO., LTD.

(21) Appl. No.: 10/354,998

(22) Filed: Jan. 31, 2003

(30) Foreign Application Priority Data
Jun. 24, 2002 (KR) 2002-35413

(51) Int. Cl. G09G 5/00

(52) U.S. Cl. 345/744

(57) ABSTRACT

A home network system which drives a remote user interface that transmits and/or controls user interface (UI) information corresponding to respective home electronic devices having a variety of output apparatuses and an operating method thereof, are provided. The home network system includes at least one or more clients; and a home server which has user interface data corresponding to the respective clients and, if a client is connected or a predetermined event occurs, transmits the user interface data to the corresponding client, wherein the client displays the user interface data transmitted by the home server.

### BACKGROUND OF THE INVENTION

1. Field of the Invention

The present invention relates to a home network system, and more particularly, to a home network system which drives a remote user interface that transmits and/or controls user interface (hereinafter referred to as “UI”) information and a driving method thereof. The present application is based on Korean Patent Application No. 2002-35413 filed on Jun. 24, 2002, which is incorporated herein by reference.

2. Description of the Related Art

FIG. 1 is a schematic diagram of a prior art home network system.

The home network system of FIG. 1 connects clients, for example, a PDA 120, a printer 130, a camcorder 140, a digital still camera (DSC) 150, and a MP3 player 160, with a home server 110.

Referring to FIG. 1, an electronic device 120, for example, a PDA or a notebook PC, which has an internally installed operating system (OS) and enough resources, is connected to the home server 110 and exchanges events with the home server 110.

However, since the camcorder 140, the DSC 150, and the MP3 player 160 do not have an OS and operate as simple firmware, and the printer 130 has an internally installed OS but does not have surplus resources, it is difficult to connect and operate these devices with the home server 110. More particularly, it is almost impossible to connect and operate the electronic devices, which operate as firmware, with the home server 110 unless the specifications of the electronic devices are upgraded.

### SUMMARY OF THE INVENTION

To solve the above problems, it is an objective of the present invention to provide a home network system which drives a remote user interface that transmits and/or controls user interface (UI) information corresponding to respective home electronic devices having a variety of output apparatuses and an operating method thereof.

To solve the above problems, it is another objective of the present invention to provide a home server apparatus and client apparatuses that drive UI information corresponding to respective home electronic devices having a variety of output apparatuses.

According to an aspect of the present invention, there is provided a home network system comprising at least one or more clients; and a home server which has user interface data corresponding to the respective clients and if a client is connected or a predetermined event occurs, transmits the user interface data to the corresponding client, wherein the client displays the user interface data transmitted by the home server.

According to another aspect of the present invention, there is provided a home server operating method for driving a remote user interface in a home network system having at least one or more clients and a home server, the method comprising (a) storing user interface data corresponding to the client connected to the network; and (b) if a predetermined event related to the client occurs, transmitting the user interface data of the step (a) to the client.

According to another aspect of the present invention, there is provided a client operating method for driving a remote user interface in a home network system having at least one or more clients and a home server, the method comprising (a) informing the home server of a network connection; (b) if an event occurs, transmitting the event to the home server; and (c) if user interface data transmitted by the home server in response to the event transmitted in the step (b) are received, displaying the data on an output apparatus.

According to another aspect of the present invention, there is provided a home server apparatus for driving a remote user interface in a home network system, the home server apparatus comprising a storage unit which stores respective user interface data corresponding to at least one or more clients; and a control unit which stores user interface data corresponding to clients connected to the network, and, if an event related to the client occurs, transmits the corresponding user interface data stored in the storage unit to the client.

According to another aspect of the present invention, there is provided a client apparatus for driving a remote user interface in a home network system comprising a storage unit which stores user interface data; and a processor unit which, if the home server is connected, transmits the user interface data stored in the storage unit to the home server, and, if an event occurs, receives user interface data from the server and displays the data on an output apparatus.

### BRIEF DESCRIPTION OF THE DRAWINGS

The above objects and advantages of the present invention will become more apparent by describing in detail preferred embodiments thereof with reference to the attached drawings in which:

FIG. 1 is a schematic diagram of a prior art home network system;

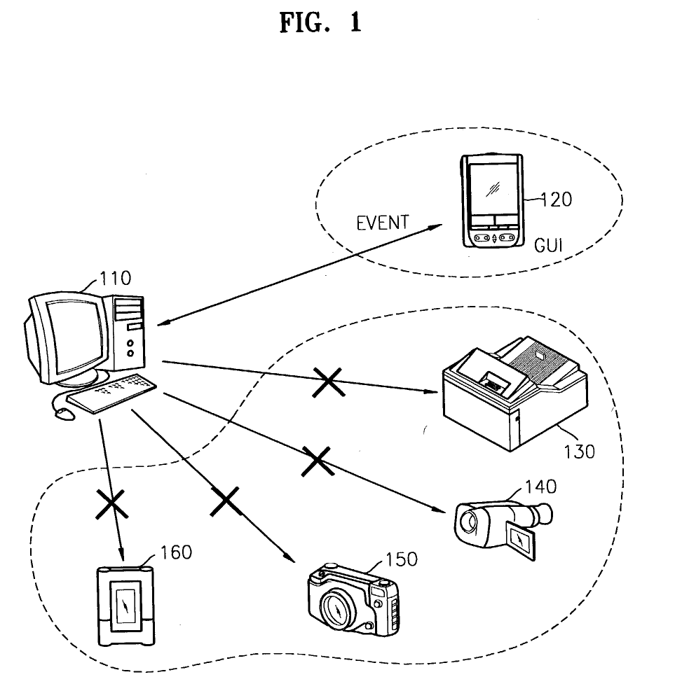

FIG. 2 is a schematic diagram of a home network system according to the present invention;

FIG. 3 is a diagram of the structure of a preferred embodiment of a client shown in FIG. 2;

FIG. 4 is a diagram of the structure of a preferred embodiment of a home server shown in FIG. 2;

FIG. 5 is a flowchart of steps performed by a preferred embodiment of the present invention when a connection is established between a home server and a client; and

FIG. 6 is a flowchart of steps performed by a preferred embodiment of the present invention when an event occurs between a home server and a client.

### DESCRIPTION OF THE PREFERRED EMBODIMENTS

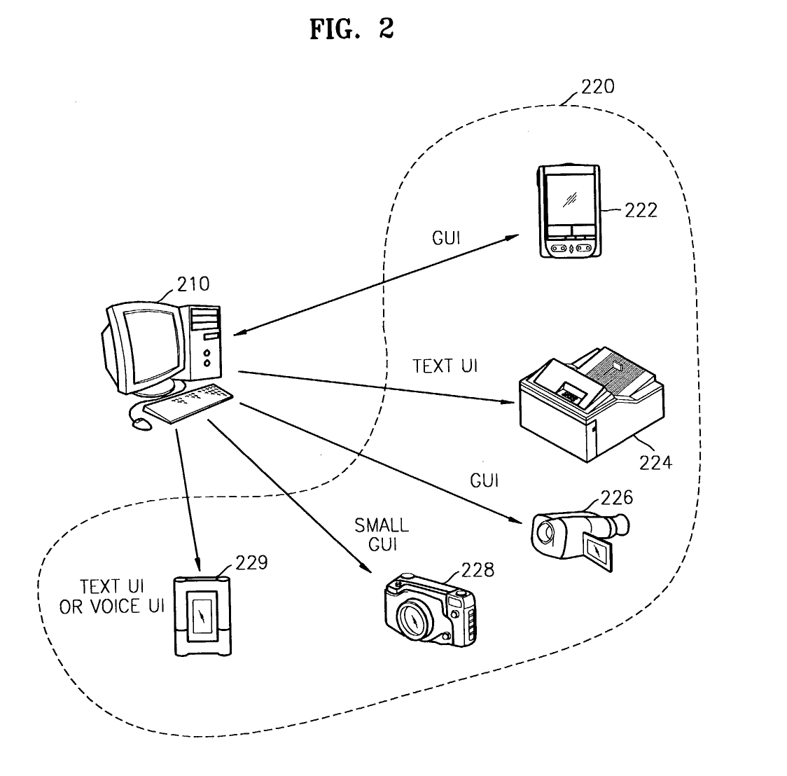

Referring to the schematic diagram of a home network system according to the present invention of FIG. 2, clients 220 are connected to a home server 210 through a wire or wireless home network.

The clients 220 include a PDA 222, a multifunction printer 224, a camcorder 226, a DSC 228, and an MP3 player 229, and the various client devices can display UI information provided by the home server 210 on respective monitors.

The home server 210 has different types of UI information corresponding to respective hardware and software resources of clients 220. If the clients 220 are connected or predetermined events occur, the home server 210 transmits UI information to a corresponding client 220. For example, the home server 210 transmits graphical user interface (GUI) information, text UI information, small-sized GUI information, and text UI/voice UI information to the PDA 222 and camcorder 228, multifunction printer 224, the DSC 228, and the MP3 player 229, respectively.

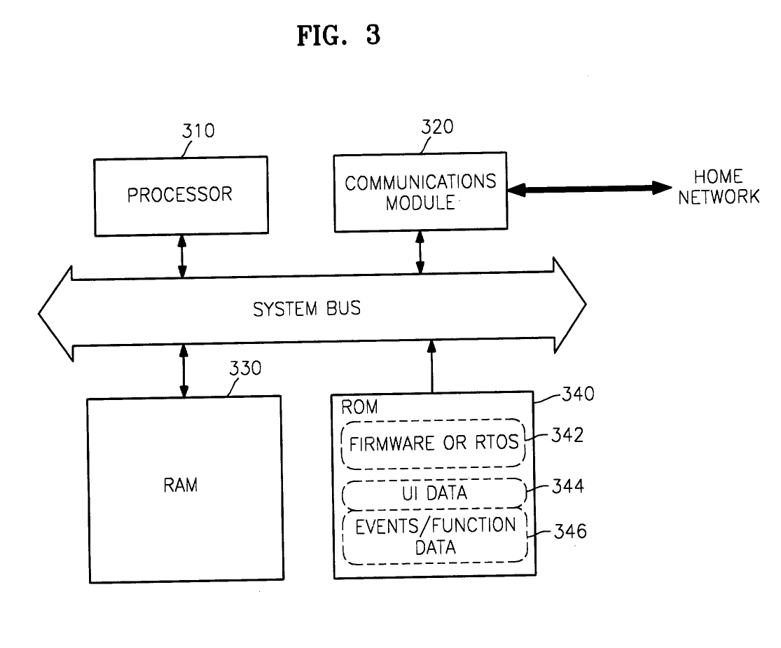

FIG. 3 is a diagram of the structure of a preferred embodiment of the client 220 shown in FIG. 2.

Referring to FIG. 3, firmware or real time operating systems (RTOS) 342, UI data 344 and event/function data 346 according to the types of devices are stored in a ROM 340. At this time, the UI data 344 are the data optimized by capabilities of the display unit, for example, the type of the display, resolution, color depth, etc. The event data are the data which are generated in the device by error occurrence, button push, media insertion, etc. Function data includes the functions the device has and the functions which should be performed when an event occurs, for example, functions defined according to different push buttons and functions that should be performed when a medium is inserted.

A program for driving a processor 310 and the RTOS is stored in a RAM 330.

A communications module 320 transmits data to and receives data from the home server 210 through the home network.

When the device is connected to the home server 210, the processor 310 reads data stored in the ROM 340, transmits the data to the home network through the communications module 320, and displays on the monitor the UI data and event/function data that are provided by the home server 210 through the home network.

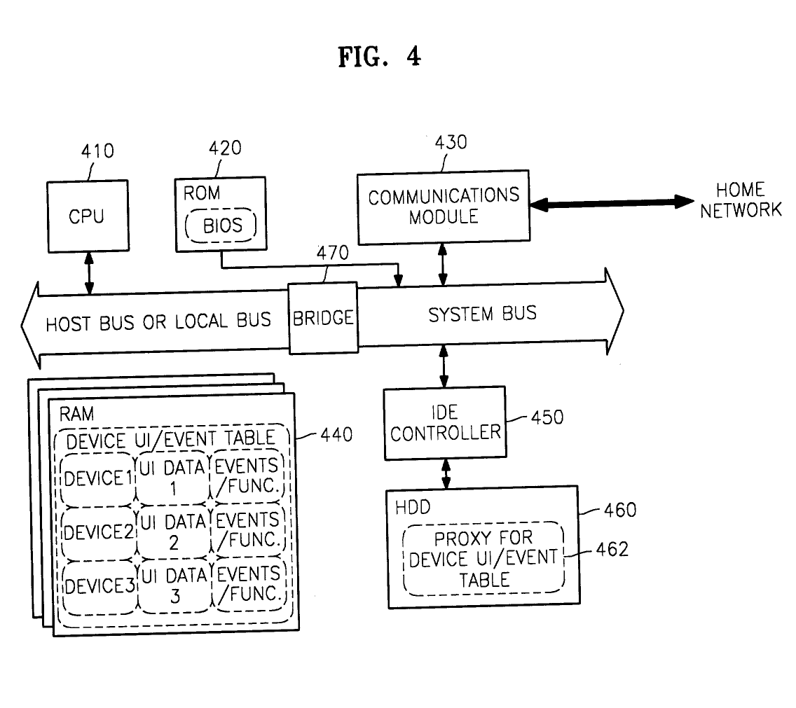

FIG. 4 is a diagram of the structure of a preferred embodiment of the home server 210 shown in FIG. 2.

Referring to FIG. 4, a basic input/output system (BIOS) is stored in a ROM 420.

A RAM 440 stores a UI/event table which is generated based on devices' names. For example, this device UI/event table stores UI data 1 and event/function data 1 that relate to a first device, UI data 2 and event/function data 2 that relate to a second device, and UI data 3 and event/function data 3 that relate to a third device.

A communications module 430 receives data from and transmits data to the client 220 through the home network.

A HDD 460 has a proxy area for storing the UI/event table of devices connected to the home server 210. Preferably, the HDD 460 stores an OS so that the OS is loaded when the system is being booted. In another preferred embodiment, the OS may be stored in the ROM 420. The proxy area stores a device UI/event table which contains the UI, events, and function data that are transmitted by the client 220.

An integrated drive electronics (IDE) control unit 450 converts data that are input through a system bus, into commands complying with an IDE interface and stores the commands in the HDD 460.

A bridge 470 connects a host bus or a local bus with a system bus, which can be buses that comply with different standards.

A CPU 410 stores the UI and event/function data that are provided by the client 220, in the RAM 440 and at the same time stores the data, as back-up data, in the proxy area 462 of the HDD 460 through the IDE control unit 450. If the identical client 220 is connected, the CPU does not receive the corresponding data from the client 220 and loads the back-up data in the proxy area 462 of the HDD 460 to the RAM 440. Also, if the client 220 is connected or a predetermined event occurs, the CPU 410 transmits the corresponding UI stored in the RAM 440 to the client 220 through the communications module 420.

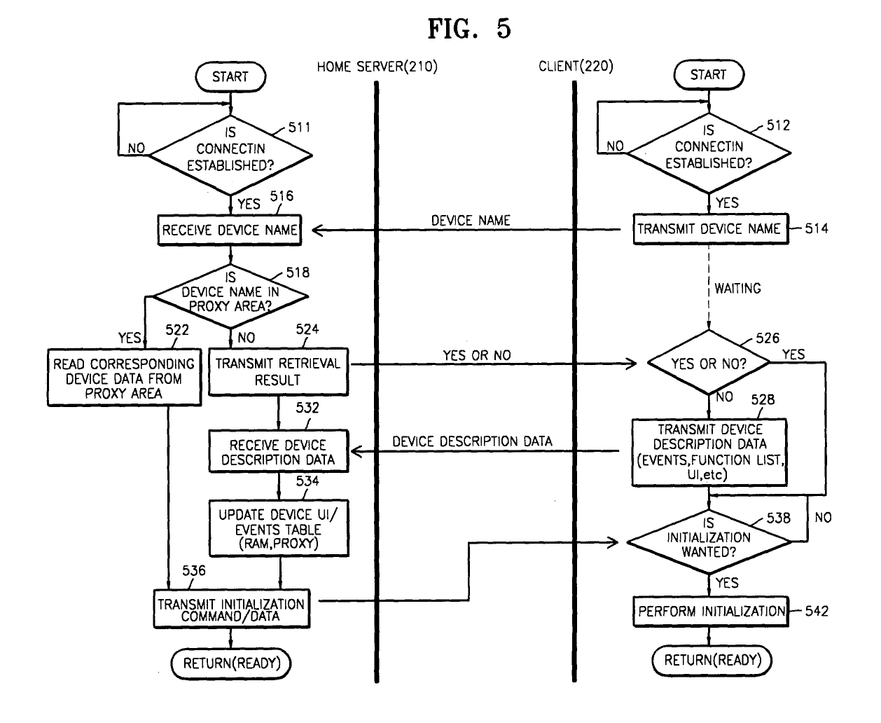

FIG. 5 is a flowchart of steps performed by a preferred embodiment of the present invention when a connection is established between the home server 210 and the client 220.

First, if the home server 210 and the client 220 are connected in steps 511 and 512, the client 220 transmits the device name in step 514.

Then, the home server 210 receives the device name in step 516.

The home server 210 retrieves the proxy area of the HDD and determines whether or not the device name is in the proxy area in step 518.

Next, if the received device name is in the proxy area, the home server 210 reads the UI and event/function data related to the device in the proxy area of the HDD in step 522. At this time, if the received device name provided by the client 220 is not in the proxy area, the home server 210 transmits the result information (yes or no) to the client 220 in step 524.

Then, the client 220 analyzes the retrieval result provided by the home server 210 in step 526. If it is determined that the device name transmitted by the client 220 is not in the proxy area of the home server 210, the client 220 transmits device description data, that is, event data, function list data, UI data, etc., to the home server 210 in step 528.

Next, if the home server 210 receives the device description data from the client 220 in step 532, the home server 210 updates the device UI/event table stored in the RAM and the proxy area in step 534.

If the home server 210 reads the device data from the proxy area or updates the device UI/event table, the home server 210 transmits the initialization command/data to the client 220 in step 536.

Then, the client 220 displays an initial screen according to the initialization command/data provided by the home server 210 in steps 538 and 542.

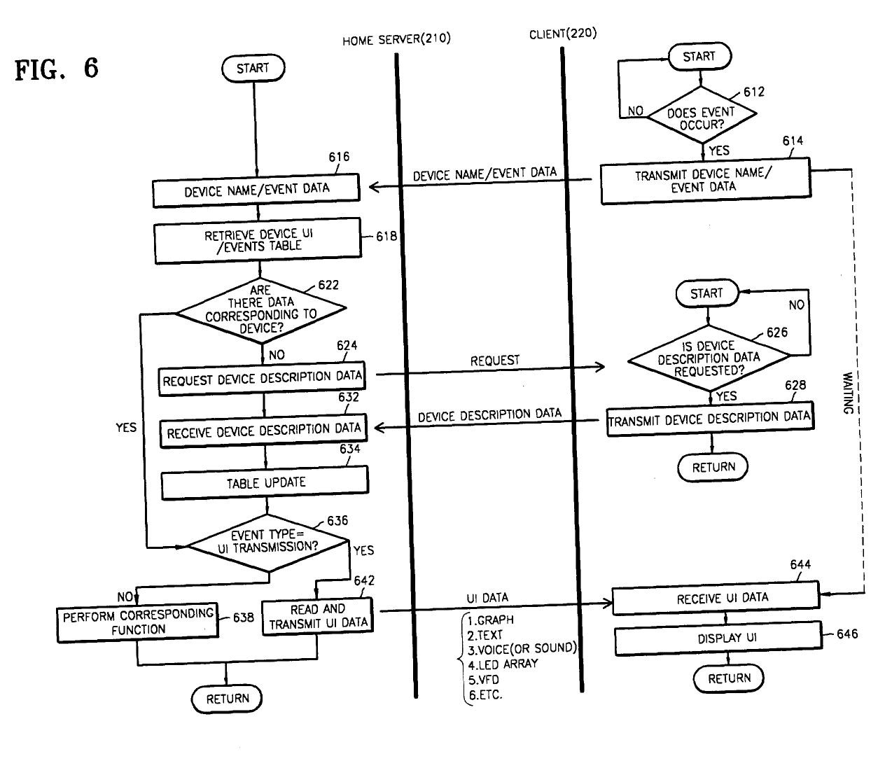

FIG. 6 is a flowchart of steps performed by a preferred embodiment of the present invention when a UI is driven between the home server 210 and the client 220.

First, the client 220 determines whether or not an event occurs in step 612.

If an event occurs, the client 220 transmits device name/event data to the home server 210 in step 614 and enters into a wait mode.

If the home server 210 receives the device name/event data, the home server 210 retrieves the device UI/event table in step 618.

Then, the home server 210 determines whether or not the UI/event data on the corresponding device are stored in step 622.

If the UI/event data on the corresponding device are not stored, the home server 210 requests the client 220 to send device description data in step 624. Here, after the client 220 checks the request for the device description data in step 626, the client 220 transmits the device description data in step 628. If the home server 210 receives the device description data, the home server 210 updates the UI/event table in step 634.

Next, if the UI/event data on the corresponding device are stored, or if the UI/event table is updated, the home server 210 determines whether or not the type of the event is a UI transmission in step 636. Here, if it is determined that the type of the event is a UI transmission, the home server 210 reads the UI data and transmits the UI data to the client in step 642. If the type of the event is not a UI transmission, the home server 210 performs another function in step 638. At this time, the UI data to be transmitted to the client 220 may have any format of a graph, text, voice/sound, LED array, and visual fluorescent display (VFD).

Then, if the client 220 receives the UI data from the home server 210 in step 644, the client 220 displays the UI on the screen in step 646.

Optimum embodiments have been explained above and are shown. However, the present invention is not limited to the preferred embodiments described above, and it is apparent that variations and modifications by those skilled in the art can be implemented within the spirit and scope of the present invention defined in the appended claims.

The present invention may be embodied in a code, which can be read by a computer, on a computer readable recording medium. The computer readable recording medium includes all kinds of recording apparatuses on which computer readable data are stored. The computer readable recording media includes storage media such as magnetic storage media (e.g., ROM's, floppy disks, hard disks, etc.), optically readable media (e.g., CD-ROMs, DVDs, etc.) and carrier waves (e.g., transmissions over the Internet). Also, the computer readable recording media can be scattered on computer systems connected through a network and can store and execute a computer readable code in a distributed mode.

According to the present invention as described above, a home network environment can be established with less cost and the user can easily manipulate home devices, by applying the remote user interface driving method by which UI information corresponding to respective home devices having a variety of output apparatuses, including a color display, a black/white display, a 7 digit light emitting diode (LED), and vacuum fluorescent display (VFD), is transmitted and controlled. Also, since the user controls the device while watching the UI displayed on the client, the user feels that he/she operates the UI regardless of the home server. That is, the user can operate the UI with the client as a master.

Since the UI data is a focus of the present invention, the UI data can be easily converted according to a user request or a trend.

What is claimed is

1. A home network system comprising:
one or more clients; and
a home server which has user interface data corresponding to respective ones of said one or more clients, wherein if at least one of said one or more clients is connected or a predetermined event occurs, the home server transmits the user interface data to said at least one of said one or more clients and said at least one of said one or more clients displays the user interface data transmitted by the home server.

2. The home network system of claim 1, wherein the user interface data contained in the home server are generated by receiving information stored in the connected said at least one of said one or more clients.

3. The home network system of claim 1, wherein each of said at least one of said one or more clients comprises:
a storage unit which stores the user interface data according to a type of a device; and
a processor unit which transmits device description information stored in the storage unit when said at least one of said one or more clients is connected to the home server, and displays the user interface data transmitted by the home server.

4. The home network system of claim 3, wherein the user interface data are data set according to a performance of a display unit belonging to a device.

5. The home network system of claim 1, wherein the home server comprises:
a storage unit which stores respective user interface data on a plurality of devices;
a proxy storage unit which stores back-up data; and
a control unit which stores device description information that is transmitted by said at least one of said one or more clients, in the storage unit and stores the device description information that is transmitted by said at least one of said one or more clients as back-up data in the proxy storage unit, and if another client is connected, loads the back-up data stored in the proxy storage unit, and if said at least one of said one or more clients is connected or a predetermined event occurs, transmits said respective user interface data stored in the storage unit to said at least one of said one or more clients, respectively.

6. The home network system of claim 5, wherein said another client of said one or more clients is substantially similar to said at least one of said one or more clients.

7. The home network system of claim 5, wherein the device description information that is transmitted to said at least one of said one or more clients is simultaneously stored in the storage unit and stored as backup data in the proxy storage unit.

8. The home network system of claim 5, wherein the storage unit stores device user data and event/function data, according to a received device name.

9. A home server operating method for driving a remote user interface in a home network system having one or more clients and a home server, the method comprising:
(a) storing user interface data corresponding to at least one of said one or more clients connected to the home network system; and
(b) if a predetermined event related to said at least one of said one or more clients occurs, transmitting the user interface data of the step (a) to said at least one of said one or more clients.

10. The method of claim 9, wherein the step (a) comprises:
retrieving a device identification (ID) transmitted by said at least one of said one or more clients connected to the home network system; and
if the device ID is retrieved, reading a stored user interface, and if the device ID is not retrieved, receiving device description information from said at least one of said one or more clients and updating a device user interface table.

11. The method of claim 9, wherein the step (b) comprises:
if event data transmitted by said at least one of said one or more clients are received, retrieving the user interface data related to said at least one of said one or more clients; and
transmitting the retrieved user interface data to said at least one of said one or more clients according to the type of the event that occurred in the step (b).

12. The method of claim 10, wherein the device description information is at least one of an event, a function list and user interface data.

13. The method of claim 11, wherein the device description information is at least one of an event, a function list, and user interface data.

14. The method of claim 9, wherein the user interface data are determined according to the display capability of said at least one of said one or more clients.

15. A client operating method for driving a remote user interface in a home network system having one or more clients and a home server, the method comprising:
(a) informing the home server of a network connection;
(b) if an event occurs, transmitting the event to the home server; and
(c) if user interface data transmitted by the home server in response to the event transmitted in the step (b) are received, displaying the data on an output apparatus.

16. The method of claim 15, further comprising:
if the home server is connected, transmitting a device name to the home server;
if information transmitted by the home server indicates that the device name is not received, transmitting device description information to the home server; and
performing initialization according to a command transmitted by the home server.

17. The method of claim 15, further comprising:
if a retrieval result from the home server indicates that the device name is not received, transmitting corresponding device description information to the home server.

18. The method of claim 16, wherein the device description information is at least one of an event, function list and user interface data.

19. The method of claim 17, wherein the corresponding device description information is at least one of an event, function list, and user interface data.

20. A home server apparatus for driving a remote user interface in a home network system, the home server apparatus comprising:
a storage unit which stores user interface data corresponding to one or more clients, respectively; and
a control unit which stores user interface data corresponding to at least one of said one or more clients connected to the network, and if an event related to said at least one of said one or more clients occurs, transmits the corresponding user interface data stored in the storage unit to said at least one of said one or more clients.

21. The home server apparatus of claim 20, further comprising:
a proxy storage unit which stores back-up data,
wherein the control unit stores device description information transmitted by said at least one of said one or more clients and stores the device description information as back-up data in the proxy storage unit, and if another of said one or more clients is connected, the back-up data stored in the proxy storage unit are loaded to the storage unit.

22. The home server apparatus of claim 21, wherein said another client of said one or more clients is substantially similar to said at least one of said one or more clients.

23. The apparatus of claim 21, wherein the control unit stores the device description information and stores the device description information as back-up data in the proxy storage unit, at the same time.

24. A client apparatus for driving a remote user interface in a home network system comprising:
a storage unit which stores device description information; and
a processor unit, which if the home server is connected, transmits the device description information stored in the storage unit to the home server, and if an event occurs, receives user interface data from the server and displays the data on an output apparatus.

25. A computer-readable recording medium for storing program codes for performing a home server operating method for driving a remote user interface in a home network system having one or more clients and a home server, the method comprising:
(a) storing user interface data corresponding to at least one of said one or more clients connected to the home network system; and
(b) if a predetermined event related to said at least one of said one or more clients occurs, transmitting the user interface data of the step (a) to said at least one of said one or more clients.

26. A computer-readable recording medium for storing program codes for performing a client operating method for driving a remote user interface in a home network system having one or more clients and a home server, the method comprising:
(a) informing the home server of a network connection;
(b) if an event occurs, transmitting the event to the home server; and
(c) if user interface data transmitted by the home server in response to the event transmitted in the step (b) are received, displaying the data on an output apparatus.
